(19) United States
(12) Patent Application Publication
(10) Pub. No.: US 2026/0362276 A1
(43) Pub. Date: Nov. 12, 2026

(54) 6G CELL SELECTION BASED ON ACTIVE AND SUPPORTED PROTOCOL MODULES

(71) Applicant: InterDigital Patent Holdings, Inc., Wilmington, DE (US)

(72) Inventors: Brian Martin, Farnham (GB); Martino Freda, Laval (CA); Keiichi Kubota, Setagaya-Ku (JP); Samuli Turtinen, Ii (FI); Faris Alfarhan, Montreal (CA); Paul Marinier, Brossard (CA); Tuong Hoang, Montreal (CA); Francois Periard, Montreal (CA); Pascal Adjakple, Great Neck, NY (US); Diana Pani, Montreal (CA); Ghyslain Pelletier, Montreal (CA); Benoit Pelletier, Roxboro (CA)

(73) Assignee: InterDigital Patent Holdings, Inc., Wilmington, DE (US)

(21) Appl. No.: 19/202,324

(22) Filed: May 8, 2025

(51) Int. Cl. H04W 36/30; H04B 17/318; H04W 36/00

(52) U.S. Cl. CPC H04W 36/302; H04B 17/328; H04W 36/0079

(57) ABSTRACT

A wireless transmit/receive unit (WTRU) may comprise a processor configured to receive configuration information from a serving cell. The configuration information may include a plurality of configuration parts, a respective identifier for each configuration part of the plurality of configuration parts, and each configuration part of the plurality of configuration parts may be applicable to the serving cell and at least a subset of a plurality of target cells. The processor may determine to evaluate the plurality of target cells based on a condition associated with performing cell selection or reselection measurements, determine a respective priority for each target cell of the plurality of target cells based on an operation mode of the WTRU, select a target cell from the plurality of target cells based on the respective priority associated with each target cell of the plurality of target cells, and send a transmission to the target cell.

### BACKGROUND

With a modular approach to protocol functionality, for example, supporting different configurations for different service types and/or requirements, which may be active in parallel, and/or the possibility of different cells supporting different subsets of functionality, the procedures for selecting the most suitable cell may be improved by being based on radio conditions and/or feature support. This may need to be taken into account for an idle mode wireless transmit/receive unit (WTRU), but the radio resource control (RRC) re-establishment for an active and/or connected WTRU may benefit from improvements in latency and cell selection for recovery.

### SUMMARY

A wireless transmit/receive unit (WTRU) may comprise a processor. The processor may be configured to receive configuration information from a serving cell. The configuration information may include, for example, a plurality of configuration parts. The configuration information may include, for example, a respective identifier for each configuration part of the plurality of configuration parts. In some examples, each configuration part of the plurality of configuration parts may be applicable to the serving cell and at least a subset of a plurality of target cells. The processor may be configured to determine to evaluate the plurality of target cells based on a condition associated with performing cell selection or reselection measurements. The processor may be configured to determine a respective priority for each target cell of the plurality of target cells based on an operation mode of the WTRU. In some examples, the operation mode of the WTRU may be associated with a subset of the plurality of configuration parts. In some examples, the subset of the plurality of configuration parts may be active at the WTRU. The processor may be configured to select a target cell from the plurality of target cells based on the respective priority associated with each target cell of the plurality of target cells. The processor may be configured to send a transmission to the target cell.

The condition associated with performing cell selection and/or reselection measurements may be when one or more channel quality measurements of the serving cell fall below a threshold. The channel quality measurements may include, for example, signal-to-noise plus interference ratio (SINR) measurements, reference signal received power (RSRP) measurements, reference signal strength indicator (RSSI) measurements, or channel quality indicator (CQI) measurements. The operation mode may be associated with an active configuration of the WTRU with the serving cell.

The processor may be configured to determine the priority associated with each target cell of the plurality of target cells based on the cell selection and/or reselection measurements.

The processor may be configured to apply a second plurality of configuration parts once connection is established with the target cell. In some examples, at least a portion of the second plurality of configuration parts may be the same as the configuration parts of the subset of the plurality of configuration parts.

The transmission may include, for example, an indication of an access type that the WTRU may use with the target cell. The access type may indicate a manner to perform configuration reception from the target cell.

The processor may be configured to determine that the condition is met based on an identification of a cell and/or carrier having a higher priority than the serving cell and/or a detection of a radio resource control (RRC) connection failure on the serving cell.

The processor may be configured to determine that the target cell may be associated with one or more configuration parts that the WTRU has active with the serving cell. The processor may be configured to execute re-establishment with the target cell prior to an expiration of a timer that may be associated with consecutive out-of-sync indications.

The processor may be configured to determine that the target cell may be associated with one or more configuration parts that the WTRU has active with the serving cell. The processor may be configured to reduce a value for a timer that may be associated with consecutive out-of-sync indications based on the priority of the target cell.

A WTRU may be configured to perform a method that includes one or more of the following steps. The method may include receiving configuration information from a serving cell. The configuration information may include, for example, a plurality of configuration parts. The configuration information may include, for example, a respective identifier for each configuration part of the plurality of configuration parts. In some examples, each configuration part of the plurality of configuration parts may be applicable to the serving cell and at least a subset of a plurality of target cells. The method may include determining to evaluate the plurality of target cells based on a condition associated with performing cell selection or reselection measurements. The method may include determining a respective priority for each target cell of the plurality of target cells based on an operation mode of the WTRU. In some examples, the operation mode of the WTRU may be associated with a subset of the plurality of configuration parts. In some examples, the subset of the plurality of configuration parts may be active at the WTRU. The method may include selecting a target cell from the plurality of target cells based on the respective priority associated with each target cell of the plurality of target cells. The method may include sending a transmission to the target cell.

The condition associated with performing cell selection and/or reselection measurements may be when one or more channel quality measurements of the serving cell fall below a threshold. The channel quality measurements may include, for example, signal-to-noise plus interference ratio (SINR) measurements, reference signal received power (RSRP) measurements, reference signal strength indicator (RSSI) measurements, or channel quality indicator (CQI) measurements. The operation mode may be associated with an active configuration of the WTRU with the serving cell.

The method may include determining the priority associated with each target cell of the plurality of target cells based on the cell selection and/or reselection measurements.

The method may include applying a second plurality of configuration parts once connection is established with the target cell. In some examples, at least a portion of the second plurality of configuration parts may be the same as the configuration parts of the subset of the plurality of configuration parts.

The transmission may include, for example, an indication of an access type that the WTRU may use with the target cell. The access type may indicate a manner to perform configuration reception from the target cell.

The method may include determining that the condition is met based on an identification of a cell and/or carrier having a higher priority than the serving cell and/or a detection of a radio resource control (RRC) connection failure on the serving cell.

The method may include determining that the target cell may be associated with one or more configuration parts that the WTRU has active with the serving cell. The method may include executing re-establishment with the target cell prior to an expiration of a timer that may be associated with consecutive out-of-sync indications.

The method may include determining that the target cell may be associated with one or more configuration parts that the WTRU has active with the serving cell. The method may include reducing a value for a timer that may be associated with consecutive out-of-sync indications based on the priority of the target cell.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 is a system diagram illustrating RLM and RLF detection/recovery in NR according to an embodiment.

FIG. 3 is a flowchart illustrating an example procedure for cell selection based on configuration parts according to an embodiment.

FIG. 4 is a system diagram illustrating cell selection based on configuration parts according to an embodiment.

### DETAILED DESCRIPTION

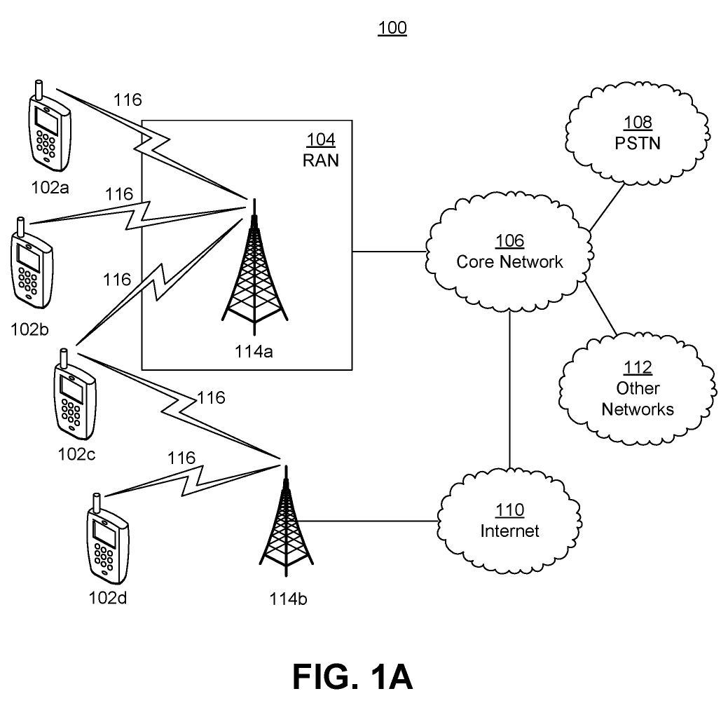

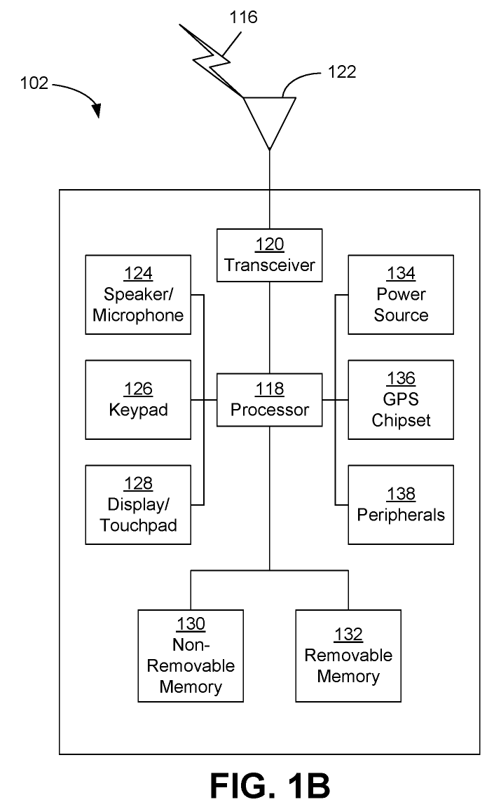

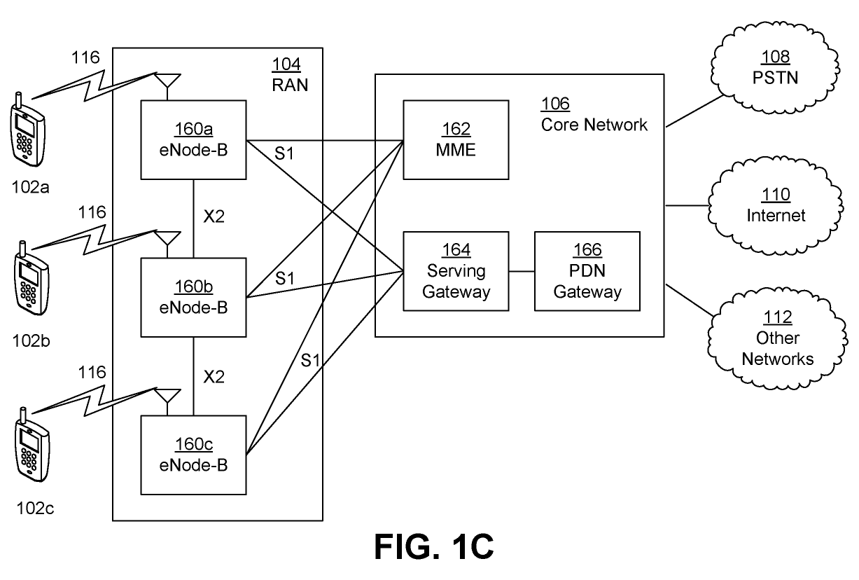

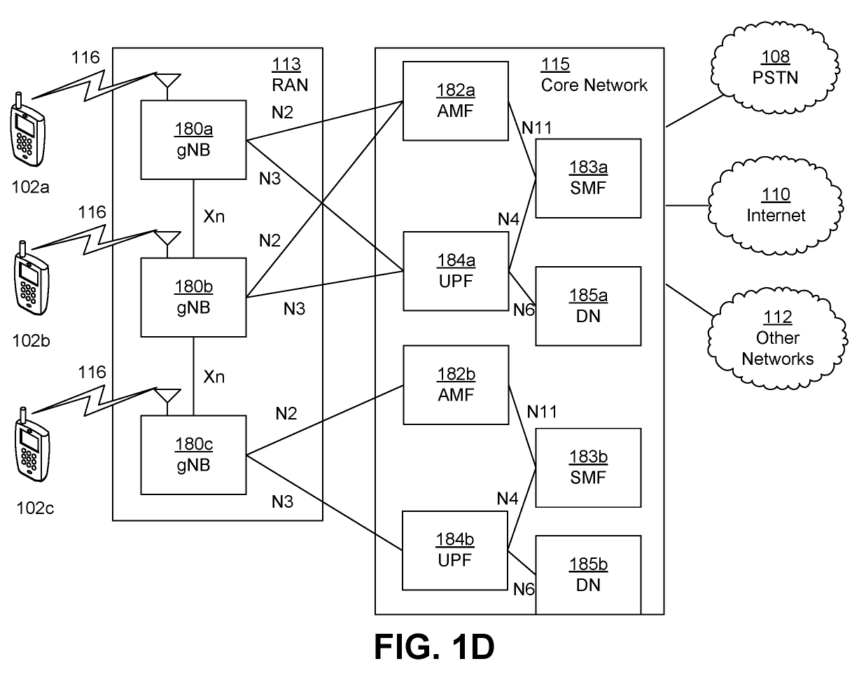

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU. Further, any description herein that is described with reference to a UE may be equally applicable to a WTRU (or vice versa). For example, a WTRU may be configured to perform any of the processes or procedures described herein as being performed by a UE (or vice versa).

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40MHz wide channel for communication, for example, via a combination of the primary 20MHz channel with an adjacent or nonadjacent 20MHz channel to form a 40MHz wide channel.

Very High Throughput (VHT) STAs may support 20MHz, 40MHz, 80MHz, and/or 160MHz wide channels. The 40MHz, and/or 80MHz, channels may be formed by combining contiguous 20MHz channels. A 160MHz channel may be formed by combining 8 contiguous 20MHz channels, or by combining two non-contiguous 80MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1GHz modes of operation are supported by 802.11af and 802.11ah. The channel operating bandwidths, and carriers, are reduced in 802.11af and 802.11ah relative to those used in 802.11n, and 802.11ac. 802.11af supports 5MHz, 10MHz and 20MHz bandwidths in the TV White Space (TVWS) spectrum, and 802.11ah supports 1MHz, 2MHz, 4MHz, 8MHz, and 16MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1MHz wide for STAs (e.g., MTC type devices) that support (e.g., only support) a 1MHz mode, even if the AP, and other STAs in the BSS support 2MHz, 4MHz, 8MHz, 16MHz, and/or other channel bandwidth operating modes. Carrier sensing and/or Network Allocation Vector (NAV) settings may depend on the status of the primary channel. If the primary channel is busy, for example, due to a STA (which supports only a 1MHz operating mode), transmitting to the AP, the entire available frequency bands may be considered busy even though a majority of the frequency bands remains idle and may be available.

In the United States, the available frequency bands, which may be used by 802.11ah, are from 902MHz to 928MHz. In Korea, the available frequency bands are from 917.5MHz to 923.5MHz. In Japan, the available frequency bands are from 916.5 MHz to 927.5MHz. The total bandwidth available for 802.11ah is 6MHz to 26MHz depending on the country code.

FIG. 1D is a system diagram illustrating the RAN 113 and the CN 115 according to an embodiment. As noted above, the CN 115 may employ an NR radio technology to communicate with the WTRUs 102a, 102b, 102c over the air interface 116. The CN 115 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 180b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a,184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

The WTRU may receive configuration parts for the current cell and/or candidate cells (e.g. conditional handover (CHO), lower layer LTM). For example, each configuration part may be associated with an identifier. The WTRU may initiate a cell selection and/or reselection. The WTRU may determine, based on the active modules (e.g., configuration parts) and/or the supported modules in the neighboring cells, priorities for neighboring cells and/or carriers. The WTRU may select a cell based on determined priorities and/or radio quality measurements. In case of radio link failure (RLF), the WTRU may determine the timing of re-establishment, for example, based on the determined priorities.

6G is expected to start in the radio access network (RAN) in Rel20. Targets for 6G may include the incorporation of sensing and/or artificial intelligence or machine learning (AI/ML) into the RAN. In some examples, changes to the protocol may be expected to address issues discovered during 5G implementation. For example, efforts towards a more unified specification that may be designed initially from day one which tailors to different categories of WTRUs and/or different verticals may be implemented. For example, to avoid the errors from 5G where narrowband internet of things (NB-IOT) and/or similar low complexity device designs may require a re-work and/or limitation of the NR baseline, 6G may take such devices into consideration. In some examples, implementing a scalable and modular design that allows a wide range of features, device types, services, and spectrum bands to be developed and deployed as needed may be implemented. In some examples, designing 6G to support diverse IoT device types and use cases from day one, with a focus on long-term commitments and multi-generational solutions may be implemented. In some examples, diverse device types with scalable design from day-1 based on, for example, bandwidth and/or data rate, form factor, and/or energy consumption may be implemented.

Additionally and/or alternatively, network energy saving may be expected to be considered from the beginning, such that the features introduced in 5G advanced to improve the network energy consumption (e.g., being able to switch off system information block one (SIB1) transmission and/or being able to switch off some of the broadcast reference signals) may be implemented from the first release. In some examples, a design consideration for 6G may be simplicity and/or streamlining of the functionality (for example, lean and streamlined standards for 6G, e.g., by dimensioning an appropriate set of functionalities, minimizing the adoption of multiple options for the same functionality, avoiding excessive configurations, etc.).

In 5G and/or LTE, it may be possible for a network to assign frequency specific priorities. For example, a WTRU may measure higher priority frequencies periodically even if the current frequency has a good quality cell. Equal and/or lower priority frequencies may be measured when coverage on the current frequency degrades. In some examples, the WTRU may apply higher priority to certain carriers based on the provided service (e.g., multicast broadcast services (MBS)).

In some examples in 5G, while individual carriers may be assigned priorities for a specific WTRU, there may not be consideration given to the possibility of different carriers and/or cells supporting different combinations of capabilities and/or configurations. For example, a modular approach to protocol design, and/or support for LTM as a baseline for mobility have been proposed. For example, with LTM, target cells may be pre-configured and the configuration may be activated upon cell switch, including failure recovery. With a modular approach it may be possible that certain cells may share all and/or part of a configuration, and it may be possible that different cells support a different combination of modules, while a WTRU may be configured with one or more modules at some times, and a different set of modules at other times (e.g., may be configured with a low capability module and a high capability module). The cell selection may be improved taking into account the currently configured modules (e.g. capabilities) and/or the supported modules in a potential target cell.

In LTE and NR, cell selection and/or reselection procedures may be similar. Cell selection is the process in which the WTRU searches the supported bands and/or frequencies to find a suitable cell for camping. Cell selection may occur after initial power on, after being out of service, and/or after experiencing a failure such as RLF. Cell reselection occurs after the WTRU has a suitable and/or acceptable cell to camp on. The WTRU performs reference signal received power (RSRP) measurements of neighbor cells (e.g., cells and/or carriers indicated by the current cell as being neighbors) and may perform an evaluation to determine whether to reselect to another cell. In some examples, frequencies may be provided with a priority. For example, the WTRU may perform measurements of frequencies with a higher priority than the current frequency. Measurements of equal and/or lower priority frequencies may take place only when the serving cell quality goes below a threshold. For example, if a cell on a higher priority frequency is above a threshold, then this cell will be reselected. If a cell on a lower priority frequency is above a threshold, and/or the quality of the current cell is below a threshold, then the new cell will be reselected. For intra-frequency and equal priority frequencies, the WTRU may perform ranking such that the cell with the highest ranking (e.g., the best RSRP) may be reselected.

Radio link monitoring (RLM) and/or RLF in NR may be implemented. In some examples, while in RRC_CONNECTED state, the WTRU may perform RLM on the serving cell (e.g., the primary cell in the case of multiple cells configured for carrier aggregation). The WTRU may be configured with timers and/or counters to use when detecting RLF and/or performing radio link recovery and/or re-establishment. The physical layer (PHY) may send out-of-sync (OOS) and in-sync (IS) indications to the radio resource control (RRC), based on whether the serving cell’s signal-to-interference plus noise ratio (SINR) is below or above a configured SINR threshold. In some examples, upon the detection of N310 consecutive OOS indications from the PHY, the RRC may start a timer with a duration of T310. While T310 is running, the WTRU may attempt to recover the radio link on the serving cell. For example, if N311 consecutive IS indications are received at RRC from PHY, the timer may be stopped and/or the WTRU considers the radio link to have been recovered and resumes normal operation and continues RLM on the serving cell. If T310 expires before the N311 consecutive IS indications are received, the WTRU may consider this as an RLF. In some examples, upon detection of RLF, a timer may be started with the duration of T311, and the WTRU may perform a cell search in order to determine whether there is a suitable cell available on which the WTRU may perform RRC connection re-establishment. If the timer T311 expires before the WTRU finds a suitable cell, the WTRU may enter RRC_IDLE mode with the cause being, for example, RRC connection failure. If the WTRU does find a suitable cell (e.g., which could be the original serving cell) then this cell is selected, T311 is stopped, T301 is started, and an RRC connection re-establishment procedure is started. If the timer T301 expires before the RRC connection re-establishment is complete, the WTRU may enter idle mode with the cause being, for example, RRC connection failure.

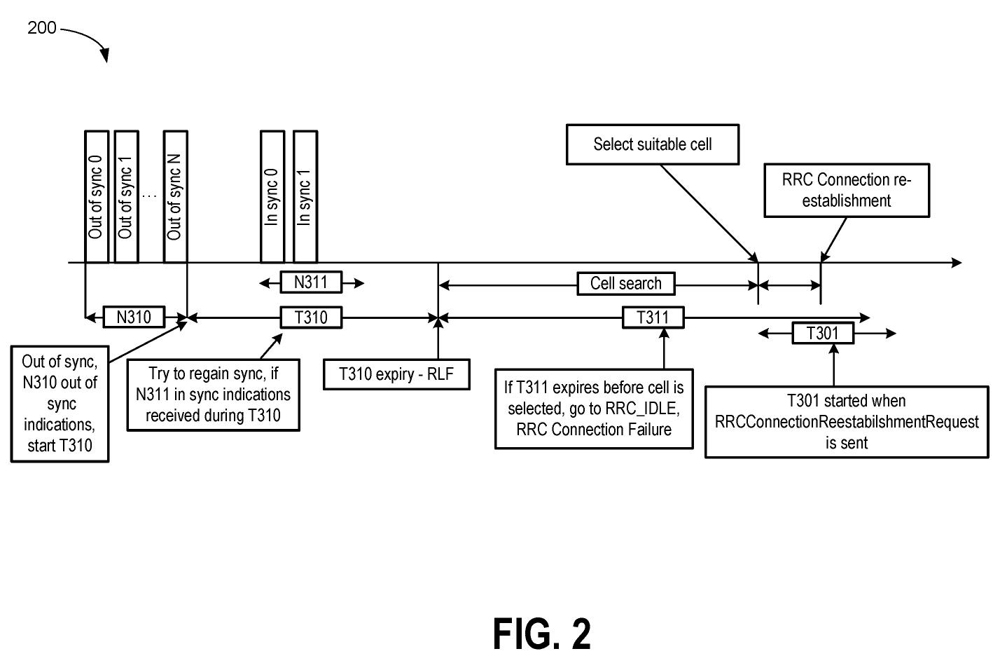

In some examples, an RLF may occur when the WTRU goes out of coverage (e.g. entering a tunnel and/or moving to a rural area out of cellular coverage). An RLF may occur, for example, as a result of a late handover, whereby RLF is detected on the serving cell before a handover can be completed. For example, the first part of the procedure (e.g., N310, T310, N311) may be intended to allow the WTRU a chance to recover the radio link in case of a temporary problem. The second part of the procedure after T310 expiry may be intended to allow the WTRU to attempt to re-establish the connection on the same and/or another cell without having to release the connection completely. FIG. 2 is a system diagram illustrating RLM and RLF detection/recovery in NR.

In some examples, a WTRU may receive from a first cell (e.g., a serving cell) one or more configuration parts applicable within multiple cells, and for particular operation modes, a WTRU may receive one or more configuration part identifiers for determining applicability. Configuration parts may correspond to modules applicable in certain operation modes.

In some examples, the WTRU may determine that a condition is met for performing cell selection and/or reselection measurements and/or evaluation For example, the WTRU may determine that the serving cell quality is below a threshold. The WTRU may determine that a periodic search for a higher priority carrier or cell is being performed. The WTRU may detect an RRC connection failure on the current cell (e.g. RLF, handover failure (HOF), reconfiguration failure, security failure, RLC failure, etc.).

In some examples, the WTRU may determine based on stored configurations and/or the current operation mode(s), target cells to prioritize for selection and/or reselection. For example, the WTRU may prioritize a cell belonging to the same group because it has the same identifier as the current and/or failed cell. For instance, the WTRU may prioritize the same radio unit (RU) first, then same distributed unit (DU), then same centralized unit (CU), then everything else. For example, the WTRU may prioritize a cell supporting a particular operation mode. For instance, the WTRU may prioritize a cell that supports same mode first, then supports next best mode, etc. The WTRU may prioritize a cell which has the particular operation mode active, over cells which support but are not currently active (e.g., cells may not be currently providing a particular service but may be allowed to request it). For example, the WTRU may prioritize a cell based on existing measurements (e.g. WTRU may have already measured and/or performed synchronization to one or more cells). The WTRU may choose a best measurement on a carrier and may change carrier if certain conditions are met. In some examples, the WTRU may select a cell based on the determined priorities, and/or the radio quality measurements.

In some examples, if the available cell has a configuration already for one or more of the currently used modules and/or capabilities (e.g. a CHO and/or LTM candidate), the WTRU may execute re-establishment immediately (e.g. stop T310). Additionally and/or alternatively, the RLF timer (e.g. T310) duration may be adjusted to a smaller value based on the determined priority of the available cell. If the available cell does not have a configuration already for one or more of the currently used modules and/or capabilities, the WTRU may attempt to re-establish on current and/or source for duration of the RLF timer. In some examples, upon applying the configuration and/or determining that a service should start and/or continue, the WTRU may send an indication to the selected cell.

In some examples, cells and/or carriers may be prioritized in a more flexible manner based on the currently active modules and/or capabilities, and the capability of the carrier and/or cell to support that. In some examples, methods described above and herein may allow prioritization during RLF recovery to cells which support the active modules. In some examples by allowing faster RLF to configure candidates and/or measured cells, the interruption may be minimized by reducing the wait time before executing re-establishment.

In some examples, synchronization signal block (SSB) and/or synchronization signal (SS)/physical broadcast channel (PBCH) block may include one or more of the following: primary synchronization signal (PSS), secondary synchronization signal (SSS), PBCH (e.g., data and/or master information block (MIB)) and/or PBCH (e.g., demodulation reference signals (DMRS)). The SSBs may be transmitted by the network (NW) node (e.g. base station, transmission/reception point (TRP), relay node, reconfigurable intelligent surface (RIS) unit) in different directions as beams. The number of SSB beams in an SSB burst set, which may be transmitted periodically within an interval (e.g. 5ms) may depend on the carrier frequency. For example, an SSB burst may contain 4 SSBs for frequency range (FR) FR1 (< 3GHz), 8 SSBs for FR1 (3 to 6GHz) and64SSBs for FR2. Certain SSBs may be transmitted as on-demand SSBs (OD-SSBs), which may possibly consist of a subset of SSBs in a burst. Such OD-SSBs may be transmitted aperiodically, semi-persistently, and/or periodically with certain periodicity. The transmission of such OD-SSBs may be triggered by the NW node and/or WTRU (e.g. via transmission of an UL wake-up signal (WUS)). Some SSBs may include slim and/or lean SSBs, which may comprise of PSS only, PSS and SSS-only, PBCH and/or a subset of MIB-only, for example. In a 6G system an SSB may use a different design. For example, an SSB may contain new reference signals and/or transmitted in a manner which allows basic (e.g. low capability) devices to receive, for example, on a very narrow bandwidth.

In some examples, system information block (SIB) may refer to any information which is broadcast by the network, either always and/or upon request, to enable devices to perform the first steps for initial access. For example, system information may consist of information related to uplink resources (e.g. random access channel (RACH)) but may also contain additional information. For instance, system information may include neighbor cell information enabling the WTRU to perform mobility between cells in an idle state, check whether access to cells are allowed, receive information related to emergency notification systems (e.g., earthquake and tsunami warning system (ETWS) and/or commercial mobile alert service (CMAS)), and/or other information which may be used by WTRUs in an idle state and/or when connecting to the cell. In NR, the system information may consist of a master information block (MIB), minimum system information (SIB1), and other system information (SIB2 through SIB25). A 6G system may use the same structure, but it may be assumed that there will be at least some minimum information used for the very first uplink communication broadcast in a first block similar to MIB, and/or some further information crucial for connecting with the cell in a second block similar to SIB1.

In some examples, channel state information (CSI) reference signals (RS) may include one or more of the following: CSI-RS resource set ID, CSI-RS resource ID and/or index, resource mapping, power control offset values (e.g. with respect to physical downlink shared channel (PDSCH), SSB, etc.), scrambling ID, periodicity, offset and/or quasi co-location (QCL) information. CSI-RS may be transmitted in DL by the NW node as CSI-RS beams, and/or via different resource types including periodic, semi-persistent and/or aperiodic. In a 6G system, CSI-RS may be transmitted upon request (e.g. on demand) to support measurements and/or beam management for connected devices, and may be transmitted using a new signal design.

In some examples, channel conditions may be conditions relating to the state of the radio and/or channel, which may be determined by the WTRU from one or more of the following. For example, channel conditions may be determined by a WTRU measurement (e.g., layer 1 (L1)/SINR/RSRP, channel quality indicator (CQI) and/or modulation and coding scheme (MCS), channel occupancy, reference signal strength indicator (RSSI), power headroom, and/or exposure headroom). Channel conditions may be determined by layer 3 (L3)/mobility-based measurements (e.g. RSRP, reference signal received quality (RSRQ), s-measure). Channel conditions may be determined by a radio link monitoring (RLM) state. Channel conditions may be determined by channel availability in unlicensed spectrum (e.g. whether the channel is occupied based on determination of a listen-before-talk (LBT) procedure and/or whether the channel is deemed to have experienced a consistent LBT failure). In some examples, the network may determine uplink channel conditions using a reference signal transmitted by the device.

As discussed herein, terms, channels, and/or protocol design for 5G NR may be used and may apply equally to any cellular network (e.g., 6G 3GPP system) which may use different definitions for channels, signals, etc. In some examples, 5G NR functions discussed herein may be necessary in a 6G system and/or future generation wireless network (e.g., depending on the system architecture, protocol design, and/or physical channel design). It may be assumed that a 6G system and/or future generation wireless network operates using the general principle that configurations may be provided by an upper layer (e.g. RRC) which may apply to multiple target cells, beam, and/or TRPs and the lower layer (e.g. MAC, L1) controls switching between the configurations. In some examples, the configuration may come from lower layers (e.g. MAC) in case different network nodes are responsible for providing their own configuration (e.g., a DU providing a layer 2 (L2) configuration and a CU providing a L3 configuration, which may use their own signaling procedures and/or design). In some examples, the radio nodes of the network may be split into CU, DU and/or RU. For example, a CU may control one or more DUs, and a DU may control one or more RUs. In some examples, the DU configuration may be provided to the CU and transmitted to the WTRU from the CU using RRC signaling, similar to NR. Additionally and/or alternatively, the DU may provide its configuration directly to the WTRU using L2 signaling.

The examples discussed herein are described in terms of accessing a new radio access technology to be defined for 6G communications. In some examples, the term 6G NR and/or 6G may refer to 6G communications radio access technology (RAT). The naming for 6G communications RAT may not be defined. However, the term 6G NR and/or 6G may be used interchangeably with other terms that may be used to describe the 6G RAT. The examples described herein may enable devices to efficiently access 6G cells in a manner that allow minimum broadcast overhead to reduce network energy consumption, minimize resource overhead, and/or enable support of low complexity devices.

In some examples, protocol modules (e.g., modular protocol) may be implemented as an approach in 6G design. A modular protocol design may include one or more of the following. For example, a modular protocol design may include an anchor baseline protocol supporting the lowest capability device (e.g., smallest supported bandwidth, minimum data rate and/or processing capability). A modular protocol design may include additional processing and/or protocol components for higher capability and/or operation modes (e.g., wider bandwidth, additional bandwidth parts, additional carriers and/or resources, and/or additional processing capabilities such as a larger number of hybrid automatic repeat request (HARQ) processes and/or additional functionality). A modular protocol design may include RRC configuration threads encoded and/or decoded in parallel. For instance, the RRC configuration of the MAC layer (e.g., and/or any protocol layer) may be separate from RRC configuration for radio resource management (RRM) (e.g., and/or any other functionality). For instance, the DU may configure functionality terminated in the DU (e.g. MAC) and/or CU may separately configure functionality terminated at the CU (e.g. RRC based RRM, packet data convergence protocol (PDCP) layer functionality, etc.). A modular protocol design may include simplified WTRU configuration structure (e.g., abstract syntax notation (ASN).1 encoding to be modelled based on lists rather than entirely nested structures). A modular protocol design may include stored configurations across state transitions (e.g., the WTRU may be moved between a power saving state (e.g. RRC_INACTIVE) and/or an active state (e.g. RRC_CONNECTED) using previously stored configurations, not needing a full RRC reconfiguration to change the state). A modular protocol design may include improved latency (e.g., state changes and/or reconfiguration may be achieved by pre-stored configurations applied upon L2 (e.g. medium access control (MAC) control element (CE)) signaling.

In some examples, defining protocol modules for modular protocol may include one or more of the following. For example, protocol modules may be defined as capability based. For instance, a module based on low capability (e.g. anchor protocol), a module based on enhanced mobile broadband (eMBB) capability, etc. For instance, capability based may include a combination of what the WTRU and/or NW supports (e.g., if the WTRU and/or NW support multiple module options, then the selected module may be the highest capability module supported by both). For instance, capability based may include having multiple modules active at the same time (e.g., minimum capability for small amount of data, signaling, initial access, etc.; intermediate capability for relatively low throughput data; and/or higher capability based on quality of service (QoS) requirements, such as lower latency, higher throughput, wider BW, higher reliability, better latency).

For example, protocol modules may be defined as building block and/or bolt-on based on functionality and/or operation modes, and/or to transfer small amounts of delay tolerant data. For instance, a first protocol module may correspond to a low capability, which could be used by any device (e.g., to perform registration signaling). A second protocol module may add more throughput capability, for example, additional carriers, resources, and/or L2 processing (e.g., HARQ processes, radio link control (RLC) functionality, memory and/or buffer, etc.), and may be enabled in parallel to the first module. In some examples, a module may be added to enable certain functionality, corresponding to one or more of the following. For instance, a module may be added to enable mobility (e.g., depending on the type of mobility configuration being enabled). A module may be added to enable link management. A module may be added to enable QoS. A module may be added to enable user plane configuration and/or control plane configuration. A module may be added to enable failure recovery mechanisms. A module may be added to enable power saving mechanisms (e.g. DRX and/or network energy saving). In some examples, different modules may correspond to different states of the WTRU (e.g., one module for power saving and another for latency).

For example, low capability may be a first module, where low capability may be sufficient for signaling and/or initial access. A second module, for example, may add low throughput data, more memory and/or buffer, and/or additional L2 parts (e.g., more HARQ processes and/or RLC capabilities). A second module may be user plane, data plane, and/or control plane modules. In some examples, a third module may add low latency and/or high reliability.

In some examples, a protocol module may encapsulate all of the functionality for a particular feature and/or set of features, providing the parameters and/or configuration across multiple protocol layers. For example, enabling a high throughput service may require configurations at L1, MAC, and/or RRC, etc.

For example, protocol modules may be defined as NW architecture based. For example, if DU is able to configure itself, one module could be DU related configuration (e.g., MAC). Another module could be CU related (e.g., RRC), and another may be RU related. For example, a module may correspond to (e.g. be applicable in) multiple cells and/or areas in the network.

In some examples, configuration parts may be used to (e.g. independently) control and/or configure different modules, or parts of modules, in the device. For example, one configuration part may describe a MAC configuration and/or a mobility configuration. One configuration part may describe a power saving configuration and/or a low latency configuration. One configuration part may describe the anchor and/or baseline protocol (e.g., lowest capability) while other configuration parts may describe the configuration for additional processing and/or protocol components for higher capability and/or operation modes. In some examples, a configuration part may describe a combination of modules, and/or smaller parts of individual modules, or may directly correspond to a particular module. In other examples, configuration parts may be common across multiple cells. For example, RRC configuration parts could be relevant to a particular group of cells such as cells bellowing to the same CU (e.g. “upper” RRC L3 configuration), same DU (e.g. L1/L2 configuration), and/or same RU (L1 configuration). RRC configuration parts could be relevant to a particular group of cells such as cells bellowing to the same location area and/or RAN notification area. RRC configuration parts could be relevant to any combination of cells using the same and/or similar configuration for at least part of the complete configuration. In some examples, configuration parts may be partly or wholly specific to a particular operation mode (e.g., eMBB mode, power saving mode, low latency mode, IoT and/or minimum capability mode, etc.).

In some examples, an operation mode may refer to a mode in which a particular one or more protocol modules are active. For example, in NR there are different RRC states which may be described as operation modes. For instance, in the RRC_CONNECTED operation mode, the WTRU may have a dedicated radio network temporary identifier (RNTI), may be scheduled using the physical downlink control channel (PDCCH) for reception on physical downlink shared channel (PDSCH) and transmission on physical uplink shared channel (PUSCH), mobility may be controlled by the network, and measurements may be performed using specific RSs. In the RRC_INACTIVE mode, the WTRU may store the connected mode context, may use common channels to start data transmission and/or reception (e.g. may be reachable by paging, and/or may initiate an RRC resume using RACH), and mobility may be WTRU based using idle mode RSs.

For 6G, it is expected that there may be at least one connected state (e.g., RRC_CONNECTED). In contrast to NR, there may be multiple operation modes in the RRC_CONNECTED state. The operation modes may correspond directly to modules and/or configuration parts, and/or may consist of multiple (e.g., a combination of) modules and/or configuration parts. For example, the mobility mode of the WTRU in RRC_CONNECTED may be changed by enabling either a network controlled mobility configuration, and/or a WTRU controlled mobility configuration. In another example, the operation mode may relate to the active services, configurations, capabilities, protocol components, and/or any of the options as described herein for modular protocol.

In some examples, the operation mode may modify the type of measurements being performed. For example, in one mode the WTRU may be configured to measure one type of reference signal on a neighbor cell (e.g., to perform cell based evaluation for a conditional handover), and in another mode the WTRU may be configured to measure another type of reference signal on a neighbor cell (e.g., to perform beam management and/or beam based handover, such as LTM). The change of measurement type may be implicit depending on the current mode. For example, if the WTRU is moved to a power saving operation mode, the WTRU may implicitly start performing measurements on more infrequent reference signals, and/or reference signals may be transmitted using a wider beam, in order to be able to switch off the receiver (e.g., discontinuous reception (DRX)) for extended periods, while in a data transfer mode the WTRU may start performing measurements on a more frequent RS and/or narrower beam RSs.

In some examples, the operation mode may be determined based on the highest capability that may be active. For example, if modular protocol defines a minimum capability and/or baseline module, while additional capabilities can be added (e.g., higher throughput, lower latency, additional carriers, wider bandwidth), then the current operation mode may correspond to that module with the highest capability and/or category.

In some examples, multiple operation modes may be active at the same time. For example, the mobility operation mode may determine what type of measurements and/or mobility are used, while the L2 operation mode may determine the peak data rate. Each of these operation modes may impact the procedures for cell selection and/or reselection and re-establishment independently, and/or a combination of modes may be used to determine the procedural choices.

In some examples, to identify which configuration parts are applicable in which cells, an identifier may be used. For example, a configuration part may be provided to the WTRU with an associated one or more identifiers. The identifier may be a single identifier, which may be part of a candidate configuration (e.g. LTM candidate configuration), and/or obtained from a cell during system information reception and/or during RRC re-establishment. For instance, each cell may have an allowed list of modules and/or configuration parts which may be indicated either by the cell itself, and/or by a cell providing configurations for neighbors.

In another example, the module IDs may be applicable within a given area. For example, a configuration part and/or module may be associated with a list of cell IDs for which this is applicable, and may include cells not configured (e.g., as LTM candidates). Another example would be to make the module IDs applicable within a given public land mobile network (PLMN), location area, RAN notification area, and/or other area definitions which may be defined for 6G and/or other cellular networks.

In some examples the module IDs may be implicit. For example, the module ID may depend on the index within a list structure (e.g., in ASN.1) configured to the WTRU (e.g., list entry 0 is ID 0, etc.). Module IDs may be grouped according to the functionality. For example, module IDs may be grouped according to DU related configuration (e.g,. MAC, L1) which may be common among cells belonging to one DU. Module IDs may be grouped according to CU related configuration (e.g., PDCP, RRC) which may be common amongst cells belonging to one DU. Module IDs may be grouped according to RU related configuration (e.g., L1) which may be common amongst cells belonging to one RU. Module IDs may be grouped according to power saving configuration (e.g., DRX configuration, RS and/or measurement type). Module IDs may be grouped according to mobility configuration (e.g., perform L1 based mobility, L3 based mobility, CHO, cell reselection, etc.). Module IDs may be grouped according to service-related configuration (e.g., baseline capability, eMBB capability, ultra-reliable low latency communications (URLLC), etc.). Module IDs may be grouped according to protocol layer specific configuration (e.g., MAC, RLC, etc.). Module IDs may be grouped according to configurations related to specific features (e.g., carrier aggregation, network energy saving (NWES), etc.). Module IDs may be grouped according to one or more of the options described for modular protocol above and herein.

In some examples, multiple module groups may be implemented. When multiple module groups are implemented, each of the module groups may need to be indexed independently. For example, DU specific modules may have an index, and/or CU specific modules may have an index. When the WTRU moves to a new cell, both the DU module index and/or the CU module index may be checked. The DU index may be the same amongst cells with the same DU (e.g., the same module configuration can be used in both cells).

In an example, a combination of indexes may need to be matched in order to re-use the same configuration. For example, DU modules indexes may be valid within a single CU. In this situation, a WTRU may consider DU index X to be valid as long as the CU module does not change, otherwise the WTRU may need to consider no DU index to match when the CU index changes. The WTRU may need to consider no DU index to match when the CU index changes, for example, if the CU is responsible for assigning DU indexes, while the DU indexes are not shared across CUs. In this example, when the WTRU determines that the CU index changes, the WTRU may consider the stored DU modules to be invalid. In another example, DU indexes may be provided per CU. For example a particular DU may be indexed by using 2 IDs (e.g., CUID, DUID). For instance, CUID1 may be associated with DUID1 and DUID2. CUID2 may be associated with a DUID1 and DUID2. In order to determine the validity of a stored module the same CUID and DUID need to be matched. In this example, we have 4 DU modules which may be references as (CUID1, DUID1), (CUID1, DUID2), (CUID2, DUID1), and (CUID2, DUID2).

In another example, every module of a particular group may have a unique ID (e.g., within a particular area). For the example above, the DUIDs would be set to 1, 2, 3, 4, and cells 1 and 2 belonging to CU1 would not set DUID 3 and 4. This situation may be simpler for WTRU implementation but may require more coordination in the network.

In some examples, the WTRU may determine a priority for one or more neighbor cells and/or carriers based on the supported modules and/or operation modes of that cell and/or carrier. In some examples, the WTRU may determine cell reselection priorities. For example, the WTRU may receive default cell reselection priorities (e.g., in system information and/or in a connection release message) for neighbor carriers. Based on the stored configurations, and the configuration of a neighbor cell and/or carrier for which of the stored configurations are supported and/or enabled, the WTRU may assign a higher priority to cells and/or carriers supporting a particular one or more of the stored configurations and a lower priority to others. For instance, a WTRU configured with a high peak rate configuration may prioritize other cells and/or carriers supporting the high peak rate.

In some examples, the priority may be determined depending on the active configurations. For example, a WTRU may have power saving modules and/or high peak rate modules. When the WTRU has power saving active, it may treat other cells and/or carriers supporting a power saving configuration as higher priority, while when the WTRU has high peak rate configuration active it may treat other cells supporting the high peak rate configuration with higher priority.

In some examples, the WTRU may rank the stored configurations and/or apply priority to the stored configurations. For example, the WTRU may assign the highest priority to cells belonging to the same DU, the second priority to cells of different DU but the same CU, and the third priority to cells of different CUs. The WTRU’s assignment of priority may apply to one or more of the module types, and may be ranked in terms of best power saving, and/or best throughout, etc.

In some examples, a suitability criteria may be used to determine whether to consider a cell for reselection. For example, the WTRU may determine whether to consider a cell for reselection based on the lack of support for a particular configuration part and/or module, and determine that a cell cannot be selected.

In some examples, and based on the priorities and/or a (re)selection criteria, the WTRU may determine whether to select another cell. For example, if a cell on a carrier with a higher priority carrier than the current cell has a radio measurement above a threshold, the WTRU may reselect that cell. If a cell on an equal and/or lower priority carrier than the current cell has a radio measurement above a threshold and the current cell measurement is below a threshold, the WTRU may select that cell. If multiple cells on higher priority carriers meet the criteria, then the WTRU may select the highest priority cell or carrier.

In some examples, the priority may be realized in different ways. For example, the cell reselection threshold may be adjusted such that a lower measurement quality threshold is used if the cell is determined to have a higher priority, and/or an offset may be applied to the cell reselection threshold and/or the ranking criteria.

In some examples, the WTRU may perform measurements according to different requirements depending on the determined priority. For example, a higher priority carrier may be measured more or less frequently and/or with stricter or less strict requirements. The measurements may further depend on the serving cell. For example, the WTRU may be required to measure higher priority carriers regardless of the measurement of the serving cell, but with a relatively infrequent search period. In some examples, if the serving cell measurement is below a threshold, the frequency of measurements taken on higher priority carriers may increase, and the measurements of equal and lower priority carriers may start.

In RLM and RLF detection and/or recovery in NR, as described in FIG. 2, the WTRU may start a timer when out of sync is detected on the current cell. In LTE, measurements may additionally be triggered on known neighbors ahead of the out of sync being detected. If the WTRU determines that the timer expires before re-gaining sync to the current cell, an RLF may be triggered. In some examples, if measurements have been started before detection of RLF, the WTRU may determine the length of the timer based on the determined priority of any measured cells. For example, the WTRU may determine to start measurements ahead of out of sync by starting measurements when the RSRP of the serving cell is below a threshold, and/or based on a particular position and/or speed. Detected cells corresponding to high priority for (re)selection may cause the RLF timer to be set to a relatively short value. The RLF may be executed sooner based on the knowledge that a high priority cell has been measured, and the WTRU may recover and/or re-establish sooner than waiting for a long timer value, minimizing service interruption. The length of the timer may be set and/or scaled according to the determined priority, and/or may be determined directly from the matching of IDs for particular configuration parts. For example, the WTRU may use a shorter RLF timer if one or more cells are detected and support the currently used operation mode, and/or a longer timer for other cells. In another example, the WTRU may use a shorter timer for cells supporting the same level of power saving, and/or a longer timer for other cells.

In some examples, the measurements of neighbor cells may start after out of sync has been detected and/or the RLF timer has been started. In this example, the running timer length may be shortened and/or the timer may be stopped and re-establishment immediately executed if a cell with a high priority and/or a matching configuration and/or operation mode is detected to be suitable.

In some examples, a WTRU may determine a preferred access type to use when receiving and/or requesting system information and/or other configuration signaling to camp and/or connect to a cell. An access type may refer to a particular way in which the WTRU may perform configuration reception. A WTRU may support one or more access types, and the network may indicate support for one or more access types. In some examples, an access type may refer to a configuration, which consists of one or more of the configuration parts, which in turn may refer to different features, modes, and/or capabilities. For example, power saving access, may correspond to a power saving configuration.

An access type may be selected based on, or correspond to, one or more of the following properties. For example, an access type may be selected based on currently stored and/or currently active modules, configuration parts, or operation modes. For instance, the WTRU may determine an access type based on the configuration currently used before performing a cell selection and/or reselection (e.g. having a power saving configuration then performing cell reselection, and/or a low latency configuration and/or high throughput configuration then performing re-establishment following RLF, etc.). An access type may be selected based on WTRU capability. For instance, WTRU capability may include maximum capability of a device (e.g., reduced capacity (RedCap) and/or narrowband, eMBB, URLLC, etc.). WTRU capability may include supported bands and/or bandwidths. WTRU capability may include number of supported carriers for carrier aggregation. WTRU capability may include maximum supported data rate. WTRU capability may include support for certain features (e.g., dual connectivity, extended reality (XR), artificial intelligence or machine learning (AI/ML), etc.). WTRU capability may include support for a particular set of features.

An access type may be selected based on type of access. For instance, the WTRU may be camping on a cell in which case a minimum performing access type may be used. The WTRU may need to connect to the cell, in which case a higher performing access type may be requested. An access type may be selected based on user and/or service preference. For instance, the device may be configured in a power saving mode. In this example, the WTRU may select a more power efficient access type, otherwise the WTRU may select a higher performing access type.

An access type may be selected based on service type (e.g., whether the WTRU is connecting to the cell for a particular type of service with certain QoS requirements, and/or certain data type). For instance, certain QoS requirements and/or certain data types may include one or more of a small data transmission, video stream, voice, web-based connectivity, high priority access and/or emergency, broadcast service, machine type communication, registration and/or attach, sensing data, AI/ML data collection, and/or low priority data report.

An access type may be selected based on configuration and/or assignment of access type. For instance, the network may assign a particular access type to a WTRU when it first registers on the network. This may be, for example, based on a non-access stratum (NAS) level change on WTRU capabilities and/or services, and/or based on a subscription type. For instance, access type may be selected based on first access vs. subsequent access. For example, a minimum capability may be used to perform the registration signaling for one or more devices, then subsequent access may depend on WTRU capability and/or other properties that may be used to determine an access type.

An access type may be selected based on selection of access type. For instance, the WTRU may select an access type based on any of the above criteria, in combination with an indication of what the network supports. For example, an indication of one or more supported access types may be received. The WTRU may select one of the supported access types indicated by the network.

In some examples, the one of the supported access types indicated by the network may not be the preferred access type. For example, the WTRU may prefer a high capability access type but the network only enables minimum capability access type. In this example, the WTRU may have to select a minimum capability access type. The WTRU may need to request further information later. For instance, the WTRU may receive the second system information and connect using a default configuration, then later receive dedicated signaling to provide additional capabilities and/or resource configurations.

In some examples, the WTRU may additionally and/or alternatively select an access type based on whether and what information it already has about the cell. For example, the WTRU may have previously accessed the cell and stored some minimum capability information about the cell. The WTRU may determine that the stored information is still valid, for example, by use of value tags similar to NR, and request only the information which is still missing but needed (e.g., the information related to higher capabilities). One or more specific access types may be defined to make this type of request, such that the WTRU may request minimum capability and maximum capability parameters, and/or only one or the other.

In some examples, the WTRU may transmit an indication in the uplink with an indication of the selected access type. In some examples, the WTRU may transmit an indication in the uplink with an indication of the selected access type only if the configuration corresponding to the selected access type is not currently being transmitted, and/or is not currently enabled.

In some examples, the uplink indication may correspond to any signal in the uplink which is transmitted by the WTRU to indicate and/or request the module to be configured, and/or to indicate that the WTRU may have applied a certain combination of configurations and/or their identities. Based on the indication and/or the selected access type, the cell may present itself accordingly. For example, a cell may configure itself, from the WTRU point of view, based on a low capability device, if the low capability access type is selected. The cell may configure itself based on a high capability device if a high capability access type is indicated.

The uplink signal may be one or more of a random access preamble, an uplink reference signal (e.g., sounding reference signal (SRS)), and/or a dedicated physical resource (e.g., a shared configured grant and/or a scheduled grant such as PUSCH). In some examples, the indication may be sent as a re-establishment request (e.g. in RRC) in a Msg3 and/or Msg5 of a RACH procedure, and/or in a first uplink transmission following RACH-less access. The uplink signal may be a low power wake up signal using a power efficient modulation scheme such as on-off keying (OOK) and/or transmitted using a power efficient radio transmitter. For example, In NR, the WTRU may transmit a wake-up signal in the uplink using a preamble configuration received from a neighbor cell. In some examples, a preamble configuration may be received. In some examples, another type of uplink signal may be configured (e.g., one or more uplink reference signals such as SRS or similar). A low-power wake up signal may be configured by indicating a reference index to one or more predetermined configurations (e.g. a table in the standard).

In some examples, the uplink signal may be sent using the resources, channel and/or carrier corresponding with an initial configuration. For example, in the situation where a cell is configured with one initial, access, and/or anchor carrier, and other carriers for particular services, the wake up signal may be sent to the initial, access, and/or anchor carrier. In another example, the wake up signal may be sent to the carrier and/or resources corresponding to the selected access type.

The uplink signal may contain an indication of the requested access type. For example, indication of the requested access type may include an explicit indication using a numerical value to indicate a selected access type. Indication of the requested access type may include an explicit index using a reference to one of a list of supported access types provided by the NW, and/or index to one or more protocol modules, configuration parts, and/or operation modes. Indication of the requested access type may include an implicit indication, for example, use of a particular reference sequence and/or use of a particular resource. Use of a particular resource may include a particular one or group of preambles, a particular time and/or frequency resource, and/or sending the wake-up to a particular carrier (e.g., if access types are associated with carriers)

In response to receiving an indication of the requested access type, the network may enable this access type. For example, a WTRU performing cell reselection and indicating that it requests a power saving configuration may be provided with a power saving configuration in response to the request.

In some examples, the access type corresponds to modules, configuration parts, and/or operation modes which are currently active, and/or currently pre-configured or stored in the WTRU. The WTRU may indicate multiple access types (e.g. multiple module IDs, multiple configurations parts, and/or multiple operation modes) depending on what is currently active and/or configured in the WTRU. In the context of cell reselection and/or RRC re-establishment, this may be a request to enable certain configurations which are known to the WTRU as being available in the new cell, but which may not be currently active in the new cell. The request may be transmitted by the WTRU before the cell selection and/or reselection either to the current cell and/or the target cell, or may be transmitted as part of the establishment and/or re-establishment procedure which occurs during and/or after the cell selection and/or reselection.

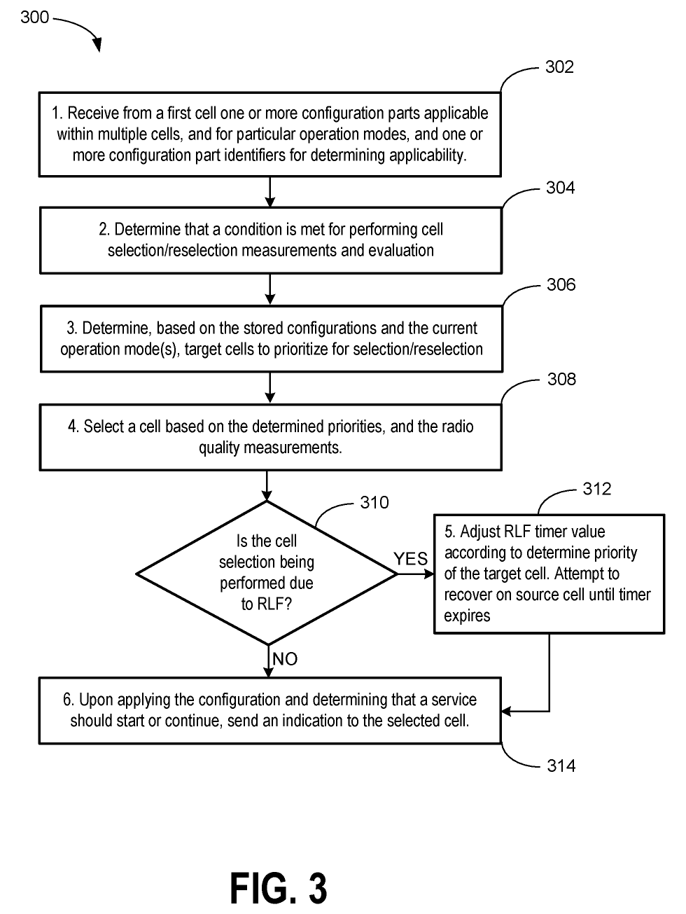

FIG. 3 is an example of a procedure 300 for cell selection based on configuration parts. The procedure 300 may be performed by a WTRU. The procedure 300 may start at 302. At 302, the WTRU may receive from a first cell one or more configuration parts applicable within multiple cells, and for particular operation modes, a WTRU may receive one or more configuration part identifiers for determining applicability. Configuration parts may correspond to modules applicable in certain operation modes.

At 304, the WTRU may determine that a condition is met for performing cell selection and/or reselection measurements and/or evaluation For example, the WTRU may determine that the serving cell quality is below a threshold. The WTRU may determine that a periodic search for a higher priority carrier or cell is being performed. The WTRU may detect an RRC connection failure on the current cell (e.g. RLF, handover failure (HOF), reconfiguration failure, security failure, RLC failure, etc.).

At 306, the WTRU may determine based on stored configurations and/or the current operation mode(s), target cells to prioritize for selection and/or reselection. For example, the WTRU may prioritize a cell belonging to the same group because it has the same identifier as the current and/or failed cell. For instance, the WTRU may prioritize the same radio unit (RU) first, then same distributed unit (DU), then same centralized unit (CU), then everything else. For example, the WTRU may prioritize a cell supporting a particular operation mode. For instance, the WTRU may prioritize a cell that supports same mode first, then supports next best mode, etc. The WTRU may prioritize a cell which has the particular operation mode active, over cells which support but are not currently active (e.g., cells may not be currently providing a particular service but allow to request it). For example, the WTRU may prioritize a cell based on existing measurements (e.g. WTRU may have already measured and/or performed synchronization to one or more cells). The WTRU may choose a best measurement on a carrier and may change carrier if certain conditions are met. At 308, the WTRU may select a cell based on the determined priorities, and/or the radio quality measurements.

At 310, the WTRU determines if the cell selection is being performed due to RLF. At 312, if RLF has occurred and if the available cell has a configuration already for one or more of the currently used modules and/or capabilities (e.g. a CHO and/or LTM candidate), the WTRU may execute re-establishment immediately (e.g. stop T310). Additionally, and/or alternatively, the RLF timer (e.g. T310) duration may be adjusted to a smaller value based on the determined priority of the available cell. If the available cell does not have a configuration already for one or more of the currently used modules and/or capabilities, the WTRU may attempt to re-establish on current and/or source for duration of the RLF timer. At 314, upon applying the configuration and/or determining that a service should start and/or continue, the WTRU may send an indication to the selected cell.

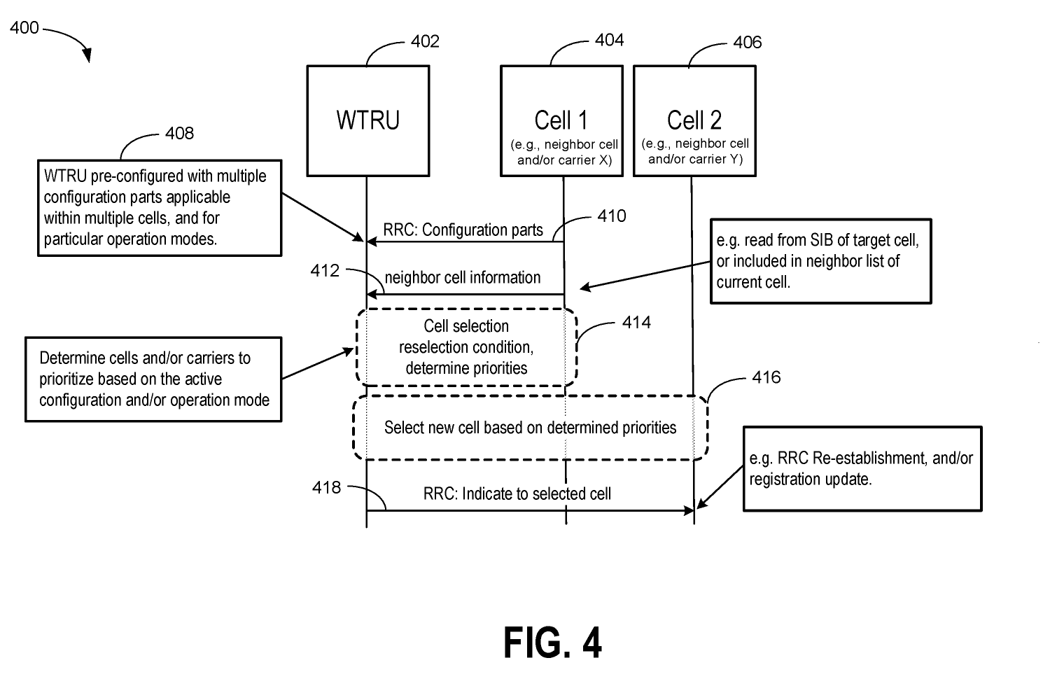

FIG. 4 is a system diagram 400 illustrating cell selection based on configuration parts according to an embodiment. In system diagram 400, the WTRU 402 is first pre-configured with multiple configuration parts 408. Each of the configuration parts may be applied together with other configuration parts to form a complete configuration. For example, there could be multiple MAC configuration parts which define different MAC configurations, and depending on which operation mode the network wants to use, the network may enable one or more of the MAC configurations. An example may be a MAC configuration for a relatively low throughput, which might use fewer HARQ processes and a less aggressive transmission mechanism, and another MAC configuration could use more HARQ processes and a more aggressive transmission mechanism. Another example may be DRX configurations, wherein one or more may provide better power saving (e.g. a longer DRX cycle) and another may provide better latency (e.g. a shorter DRX cycle).

Following and/or with the pre-configuration, the network may signal a configuration to use, for example, one or more configuration parts to combine. The configuration to use may be signaled in RRC (410), and/or it could be a MAC-CE or other downlink signaling. The configuration may be a list of configuration part IDs, and/or may be an ID which references a group of configuration parts. For example, a full configuration ID may be associated with multiple configuration part IDs.

In addition to the RRC configuration parts and/or module configurations, the WTRU may be provided with information on what is supported in the neighbor cells and/or carriers (412). For example, the WTRU may receive an indication that on the neighbor cell/carrier 404 (e.g., X), features A, B, and/or C are supported. The WTRU may receive an indication that on the neighbor cell/carrier 406 (e.g., Y) that features B, C, D are supported. If the WTRU has an active configuration corresponding to feature A, then cell/carrier X may be prioritized. If the WTRU has an active configuration corresponding to feature D then cell/carrier Y may be prioritized. For features B, C then both cell/carriers X and Y support this, therefore the WTRU may select based on measurements (e.g., select the best cell amongst carriers X and Y) (414).

When performing the cell selection and/or reselection evaluation, the WTRU may use the determined priorities (416). For instance, in the example of feature A, carrier X will have a higher priority than carrier Y. Based on radio quality measurements of carrier X and Y, the WTRU may perform cell reselection evaluation using the determined priorities and selects carrier X or carrier Y, if the corresponding radio quality measurement criteria are met (418).

In some examples, the WTRU may exclude a cell and/or carrier from cell selection and/or reselection if the relevant feature and/or module is not supported on that cell and/or carrier. In other examples, the WTRU may consider this cell and/or carrier, but if this cell is selected then the active feature and/or module may have to be deactivated and/or reconfigured.

1. A wireless transmit/receive unit (WTRU) comprising:
a processor configured to:
receive configuration information from a serving cell, wherein the configuration information comprises a plurality of configuration parts, wherein the configuration information comprises a respective identifier for each configuration part of the plurality of configuration parts, and wherein each configuration part of the plurality of configuration parts is applicable to the serving cell and at least a subset of a plurality of target cells;
determine to evaluate the plurality of target cells based on a condition associated with performing cell selection or reselection measurements;
determine a respective priority for each target cell of the plurality of target cells based on an operation mode of the WTRU, wherein the operation mode of the WTRU is associated with a subset of the plurality of configuration parts, and wherein the subset of the plurality of configuration parts are active at the WTRU;
select a target cell from the plurality of target cells based on the respective priority associated with each target cell of the plurality of target cells; and
send a transmission to the target cell.

2. The WTRU of claim 1, wherein the condition associated with performing cell selection or reselection measurements is when one or more channel quality measurements of the serving cell fall below a threshold.

3. The WTRU of claim 2, wherein the channel quality measurements comprise signal-to-noise plus interference ratio (SINR) measurements, reference signal received power (RSRP) measurements, reference signal strength indicator (RSSI) measurements, or channel quality indicator (CQI) measurements.

4. The WTRU of claim 1, wherein the operation mode is associated with an active configuration of the WTRU with the serving cell.

5. The WTRU of claim 1, wherein the processor is configured to:
determine the priority associated with each target cell of the plurality of target cells based on the cell selection or reselection measurements.

6. The WTRU of claim 1, wherein the processor is configured to:
apply a second plurality of configuration parts once connection is established with the target cell, wherein at least a portion of the second plurality of configuration parts is the same as the configuration parts of the subset of the plurality of configuration parts.

7. The WTRU of claim 1, wherein the transmission comprises an indication of an access type that the WTRU uses with the target cell, wherein the access type indicates a manner to perform configuration reception from the target cell.

8. The WTRU of claim 1, wherein the processor is configured to:
determine that the condition is met based on (i) an identification of a cell or carrier having a higher priority than the serving cell or (ii) a detection of a radio resource control (RRC) connection failure on the serving cell.

9. The WTRU of claim 1, wherein the processor is configured to:
determine that the target cell is associated with one or more configuration parts that the WTRU has active with the serving cell; and
execute re-establishment with the target cell prior to an expiration of a timer that is associated with consecutive out-of-sync indications.

10. The WTRU of claim 1, wherein the processor is configured to:
determine that the target cell is associated with one or more configuration parts that the WTRU has active with the serving cell; and
reduce a value for a timer that is associated with consecutive out-of-sync indications based on the priority of the target cell.

11. A method performed by a wireless transmit/receive unit (WTRU), the method comprising:
receiving configuration information from a serving cell, wherein the configuration information comprises a plurality of configuration parts, wherein the configuration information comprises a respective identifier for each configuration part of the plurality of configuration parts, and wherein each configuration part of the plurality of configuration parts is applicable to the serving cell and at least a subset of a plurality of target cells;
determining to evaluate the plurality of target cells based on a condition associated with performing cell selection or reselection measurements;
determining a respective priority for each target cell of the plurality of target cells based on an operation mode of the WTRU, wherein the operation mode of the WTRU is associated with a subset of the plurality of configuration parts, and wherein the subset of the plurality of configuration parts are active at the WTRU;
selecting a target cell from the plurality of target cells based on the respective priority associated with each target cell of the plurality of target cells; and
sending a transmission to the target cell.

12. The method of claim 11, wherein the condition associated with performing cell selection or reselection measurements is when one or more channel quality measurements of the serving cell fall below a threshold.

13. The method of claim 12, wherein the channel quality measurements comprise signal-to-noise plus interference ratio (SINR) measurements, reference signal received power (RSRP) measurements, reference signal strength indicator (RSSI) measurements, or channel quality indicator (CQI) measurements.

14. The method of claim 11, wherein the operation mode is associated with an active configuration of the WTRU with the serving cell.

15. The method of claim 11, wherein the method further comprises:
determining the priority associated with each target cell of the plurality of target cells based on the cell selection or reselection measurements.

16. The method of claim 11, wherein the method further comprises:
applying a second plurality of configuration parts once connection is established with the target cell, wherein at least a portion of the second plurality of configuration parts is the same as the configuration parts of the subset of the plurality of configuration parts.

17. The method of claim 11, wherein the transmission comprises an indication of an access type that the WTRU uses with the target cell, wherein the access type indicates a manner to perform configuration reception from the target cell.

18. The method of claim 11, wherein the method further comprises:
determining that the condition is met based on (i) an identification of a cell or carrier having a higher priority than the serving cell or (ii) a detection of a radio resource control (RRC) connection failure on the serving cell.

19. The method of claim 11, wherein the method further comprises:
determining that the target cell is associated with one or more configuration parts that the WTRU has active with the serving cell; and
executing re-establishment with the target cell prior to an expiration of a timer that is associated with consecutive out-of-sync indications.

20. The method of claim 11, wherein the method further comprises:
determining that the target cell is associated with one or more configuration parts that the WTRU has active with the serving cell; and
reducing a value for a timer that is associated with consecutive out-of-sync indications based on the priority of the target cell.
